(19) United States
(12) Patent Application Publication
(10) Pub. No.: US 2018/0356320 A1
(43) Pub. Date: Dec. 13, 2018

(54) SYSTEMS AND METHODS FOR SUBSTANCE DETECTION USING POSITIVE DOPANTS

(71) Applicant: Rapiscan Systems, Inc., Torrance, CA (US)

(72) Inventors: Vladimir Romanov, Pelham, NH (US); Udo H. Verkerk, Toronto (CA); Hanh Lai, Arlington, MA (US); Stefan Lukow, Hampstead, NH (US)

(21) Appl. No.: 15/616,433

(22) Filed: Jun. 7, 2017

(51) Int. Cl. G01N 1/44; G01N 27/62

(52) U.S. Cl. CPC G01N 1/44; G01N 27/62

(57) ABSTRACT

The present disclosure is directed to methods and systems for detecting a substance of interest. The methods and systems include modifying a dopant precursor to release a dopant, and contacting the dopant with the substance of interest. The systems and methods further include performing an analysis of the substance of interest and detecting the substance of interest.

### BACKGROUND OF THE DISCLOSURE

The embodiments described herein relate generally to detection techniques for chemical substances, and, more particularly, to generating an ammonia dopant using various dopant precursors. More specifically, the methods and systems include modifying a dopant precursor to release ammonia as a dopant for contact with a substance of interest. The systems and methods further include performing an analysis on the substance of interest to detect the substance of interest.

Dopants may be used to increase detection sensitivity and/or selectivity for certain substances of interest (e.g., explosives and narcotics). In some instances, it may be desirable to generate the dopant from a dopant precursor. However, some dopant precursors may have a highly variable (and consequently less controllable) emission rate of the respective dopant over the temperature operating ranges. That is, variations in temperature may significantly vary the emission rate of dopant from the dopant precursor. The release of an excess amount of dopant adversely affects detection of the substance of interest.

There is a need, therefore, for detection systems and methods that utilize dopant precursors to release a dopant at a generally constant and well-controlled dopant emission rate. The present disclosure achieves these benefits while increasing the range of operating temperatures and eliminating or decreasing the potential for adversely affecting detection of substances of interest due to the presence of excess dopant.

### BRIEF DESCRIPTION OF THE DISCLOSURE

In one embodiment of the present disclosure, a method for detecting a substance of interest is disclosed. The method includes introducing a substance of interest into a device of a trace detection system, and heating a dopant precursor to release a dopant, wherein the dopant precursor comprises at least one of urea, an organic ammonium salt, a guanidinium inorganic salt, an ammonium polyphosphate, and a substituted amide. The method also includes introducing the dopant into the device of the trace detection system, wherein the dopant contacts the substance of interest, and performing an analysis of the substance of interest. The method further includes detecting the substance of interest.

In another embodiment of the present disclosure, a method for detecting a substance of interest is disclosed. The method includes introducing a substance of interest into a device of a trace detection system, and catalytically decomposing a dopant precursor to release a dopant, wherein the dopant precursor comprises at least one of urea, an organic ammonium salt, a guanidinium inorganic salt, an ammonium polyphosphate, and a substituted amide. The method also includes introducing the dopant into the device of the trace detection system, wherein the dopant contacts the substance of interest, and performing an analysis of the substance of interest. The method further includes detecting the substance of interest.

In yet another embodiment of the present disclosure, a system for detecting a substance of interest is disclosed. The system includes an inlet configured to receive a substance of interest, and a dopant precursor, wherein the dopant precursor comprises at least one of urea, an organic ammonium salt, a guanidinium inorganic salt, an ammonium polyphosphate, and a substituted amide. The system also includes a modifier configured to modify the dopant precursor to release a dopant. The system further includes an analysis device coupled in flow communication with the inlet, wherein the analysis device is configured to perform an analysis on the substance of interest.

### BRIEF DESCRIPTION OF THE DRAWINGS

FIG. 1A is an exemplary embodiment of a graphical depiction of emission rates for anisole, methyl salicylate, and ammonium carbamate in accordance with the present disclosure. FIG. 1B is an exemplary embodiment of a graphical depiction of emission rates for anisole, methyl salicylate, and ammonium carbamate in accordance with the present disclosure.

FIG. 2A is an exemplary embodiment of an internal calibration for methyl salicylate in accordance with the present disclosure. FIG. 2B is an exemplary embodiment of an internal calibration for methyl salicylate in accordance with the present disclosure.

FIG. 3A is an exemplary embodiment of reactant ion peak areas in accordance with the present disclosure.

FIG. 3B is an exemplary embodiment of reactant ion peak areas in accordance with the present disclosure.

FIG. 4 is an exemplary embodiment of a block diagram of a trace detection system in accordance with the present disclosure.

### DETAILED DESCRIPTION OF THE DISCLOSURE

Trace detection systems are utilized for analyzing, detecting, and identifying various substances of interest, such as explosives and narcotics. In some embodiments of the present disclosure, a dopant (or dopants) is added to increase detection sensitivity and or selectivity of a substance of interest. In some embodiments, the substance of interest includes at least one of an explosive, an energetic material, a taggant, a narcotic, a toxin, a chemical warfare agent, a biological warfare agent, a pollutant, a pesticide, a toxic industrial chemical, a toxic industrial material, a homemade explosive, a pharmaceutical trace contaminant, a biomarker for medical applications, a chemical marker for medical applications, a biomarker for clinical hygienic applications, a chemical marker for clinical hygienic applications, a precursor thereof, a byproduct thereof, a metabolite thereof, and combinations thereof. In some embodiments, a substance of interest comprises a reactant ion of interest and an ion cluster of interest.

In some embodiments, dopants are introduced into a trace detection system directly as a gas phase dopant, or are generated from a dopant precursor as needed. In some embodiments, the dopant precursor is a solid phase precursor, a liquid phase precursor, or gas phase precursor, such that some type of modification is required to release the desired gas phase dopant. For example, in some embodiments, a dopant precursor (e.g., as contained in a dopant chamber, reservoir, tube, bottle, or block) is heated to release dopant vapor into a trace detection system.

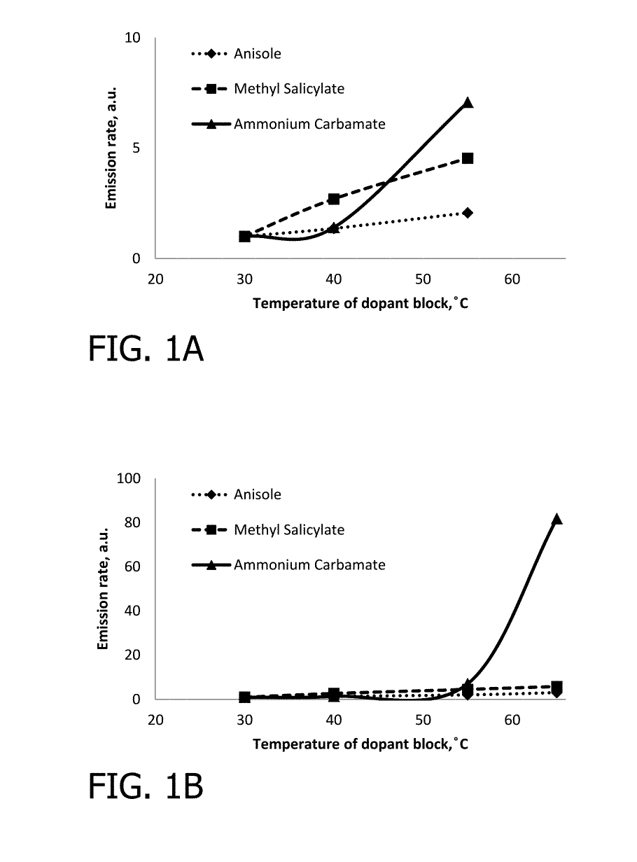

FIG. 1A is an exemplary embodiment of a graphical depiction of emission rates for methyl salicylate (MS) internal calibrant, anisole dopant, and ammonia dopant from ammonium carbamate (AC) dopant precursor at dopant block temperatures from about 30° C. to about 55° C. in accordance with the present disclosure. FIG. 1B is an exemplary embodiment of a graphical depiction of emission rates for anisole, MS, and AC from about 30° C. to about 65° C. in accordance with the present disclosure. With respect to FIGS. 1A and 1B, anisole is used a dopant and MS is used as an internal calibrant, while AC is used as a dopant precursor for releasing ammonia as dopant. At about 30° C., anisole and MS are present in the liquid phase and release gas-phase anisole and MS, respectively, when heated. No decomposition of anisole or MS occurs between about 30° C. and about 55° C. or between about 30° C. and about 65° C. In the embodiments shown in FIGS. 1A and 1B, AC is used as a dopant precursor for ammonia dopant. At about 30° C., AC is present in the solid phase and decomposes when heated to release ammonia in the gas phase.

Table 1 (see FIGS. 1A and 1B) is shown below. Emission rate specifications at about 30° C. are “x” a.u. for anisole, “z” a.u. for AC, and “y” a.u. for MS (where a.u. represents arbitrary units for the emission rate, such as μg/min). As FIGS. 1A, 1B, and Table 1 show the relative emission rates for both anisole and MS exhibit relatively well-controlled, slowly increasing emission rates as temperature of the dopant block is increased. However, the emission rate for AC begins to significantly increase and is not well-controlled above about 55° C. Consequently, detection conditions near and above about 55° C. are not suitable for providing a constant, well-controlled dopant emission rate for ammonia dopant from ammonium carbamate.

TABLE 1
Emission rate, a.u.

| T (° C.) | Anisole | MS | AC |
|---|---|---|---|
| 30 | x | y | z |
| 40 | x | 3y | z |
| 55 | 2x | 5y | 7z |
| 65 | 3x | 6y | 82z |

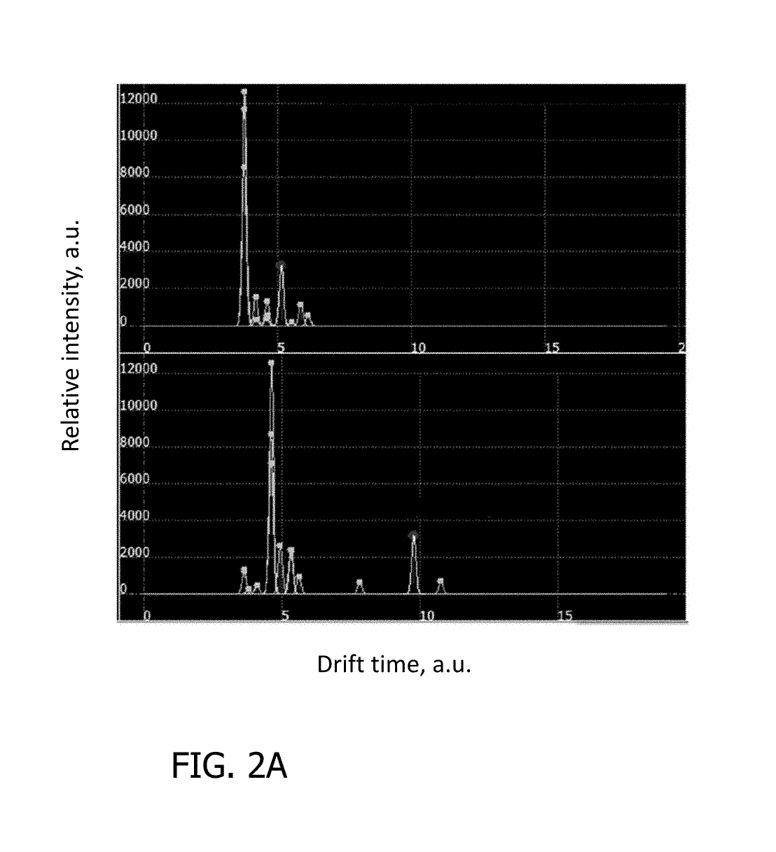

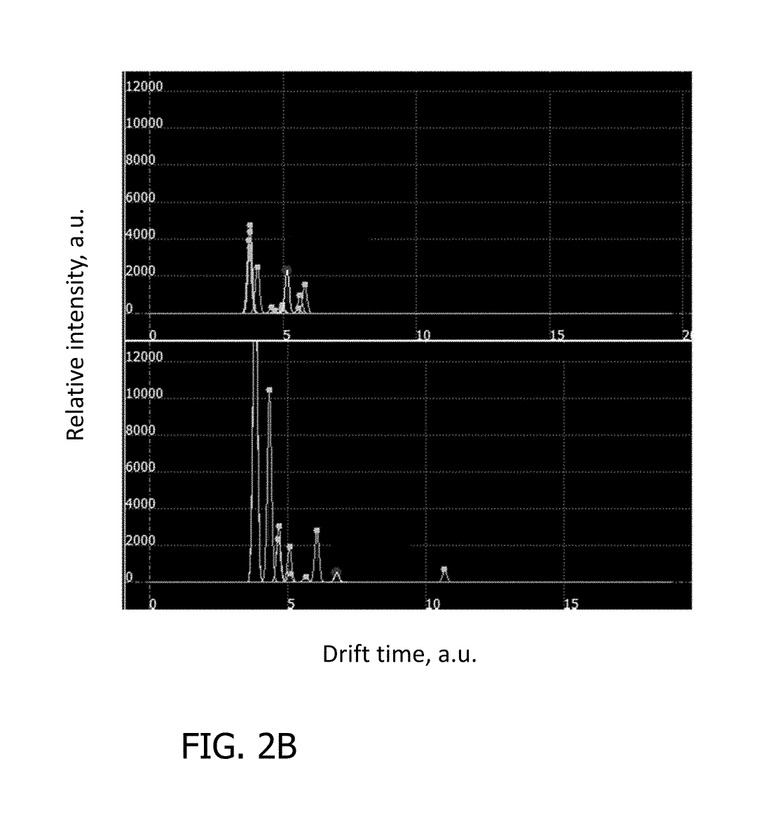

FIGS. 2A and 2B are exemplary embodiments of internal calibration for methyl salicylate (MS) at a dopant block temperature of about 29° C. and about 65° C., respectively, in accordance with the present disclosure. In each figure the top portion depicts a negative mode spectrum, while the bottom portion depicts a positive mode spectrum. The bottom portion of FIG. 2A shows the MS calibrant peak in positive mode at a drift time of about 9.8 arbitrary units. The top portion of FIG. 2A shows that no MS calibrant peak at or near a drift time of 9.8 arbitrary units is detected in negative mode. In comparing the bottom portions of FIGS. 2A and 2B, significant peak suppression is seen when using MS as a calibrant in positive mode when a temperature of the dopant block is raised from about 29° C. (FIG. 2A) to about 65° C. (FIG. 2B). Specifically, the bottom portion of FIG. 2B shows no MS calibrant peak, indicating a false negative result for MS at the higher temperature of about 65° C. versus at about 29° c.

Further, as seen in the top portion of FIG. 2A, a relatively strong (i.e., high intensity) peak of MS appears in negative mode at a drift time of about 5.1 arbitrary units. The same peak is present in negative mode in the top portion of FIG. 2B, however, at a smaller intensity. This is significant because it indicates that not only is the peak position relevant, but the strength of the peak intensity is also important because if the strength is too small, then the system will ignore it and not calibrate it.

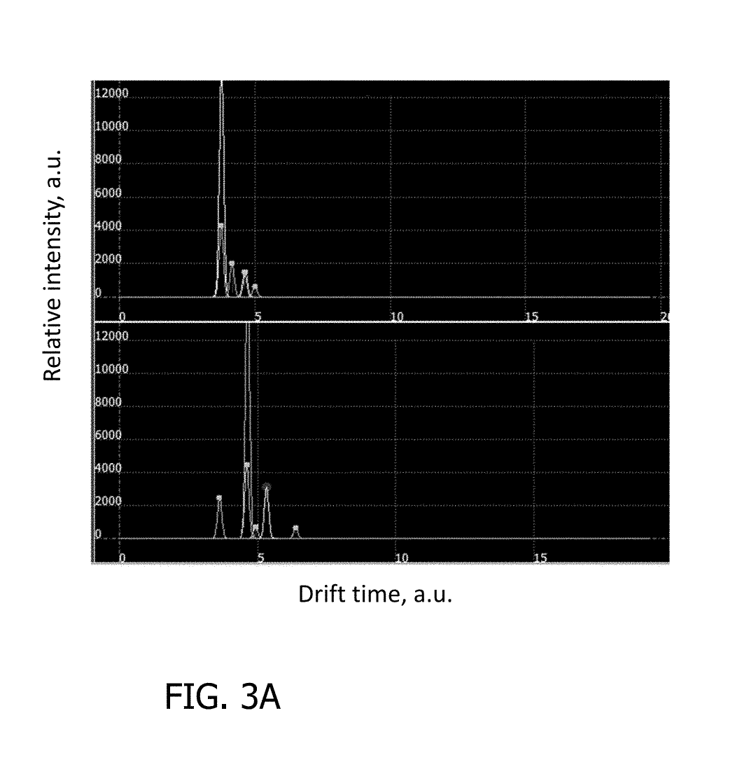

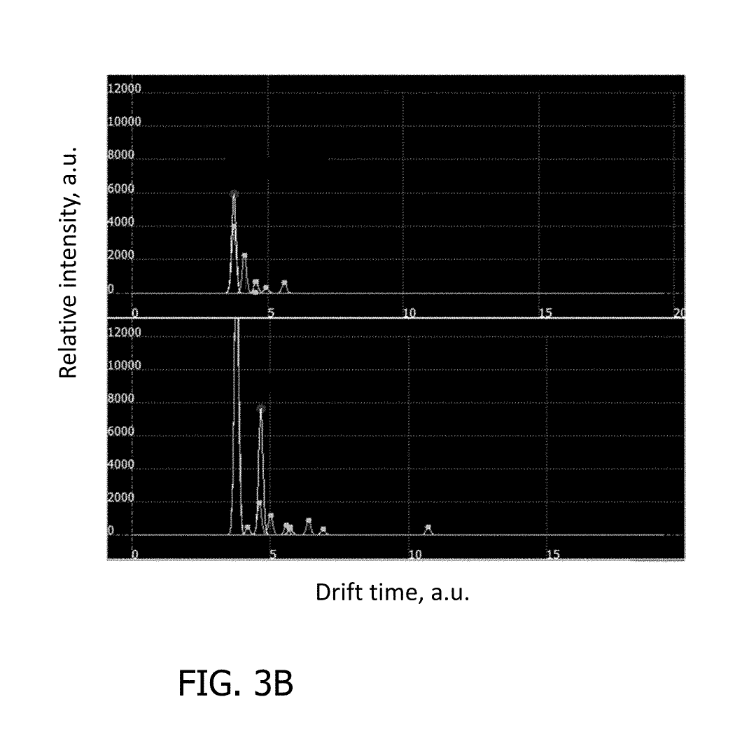

FIGS. 3A and 3B are exemplary embodiments of reactant ion peak areas at a dopant block temperature of about 29° C. and about 65° C., respectively, in accordance with the present disclosure. In these exemplary embodiments, ammonium carbamate is used as a dopant precursor for ammonia dopant. In each figure, the top portion depicts a negative mode spectrum, while the bottom portion depicts a positive mode spectrum. FIGS. 3A and 3B show that various reactant ion peaks are adversely affected (e.g., suppressed) by the increased dopant emission rate of ammonia from ammonium carbamate precursor when the dopant block temperature is raised from about 29° C. (FIG. 3A) to about 65° C. (FIG. 3B). For instance, the reactant ion peak at a drift time of about 3.6 arbitrary units has a high response intensity in the positive mode at the lower temperature of about 29° C. (bottom portion of FIG. 3A). However, the response intensity of the 3.6 arbitrary units reactant ion peak is significantly lower at about 65° C. (bottom portion of FIG. 3B). Further, the reactant ion peak at a drift time of about 3.6 arbitrary units is present in the top portion of FIG. 3A at a very high intensity but at a much lower intensity in the bottom portion of FIG. 3B. These results are attributed to the higher, uncontrolled emission rate of ammonia from ammonium carbamate precursor at the higher temperature, as further discussed below.

Ammonia dopant precursors include, for example, ammonium carbamate, urea, and guanidinium carbonate. Upon heating, each of ammonium carbamate, urea, and guanidinium carbonate release ammonia that is used as a dopant in a trace detection system. The emission rate of ammonia from each respective dopant precursor is dependent on the thermal stability of the dopant precursor at a given temperature. For instance, ammonium carbamate shows a high rate of thermal decomposition at temperatures above about 50° C. In contrast, thermal decomposition for guanidinium carbonate and urea begins at temperatures above about 150° C. Consequently, ammonia dopant precursors including urea and guanidinium carbonate are advantageous for use in trace detection systems due to their higher thermal decomposition temperatures (above about 150° C.) versus ammonia precursors such as ammonium carbamate that thermally decomposes at lower (e.g., ambient) detection temperatures near about 50° C.

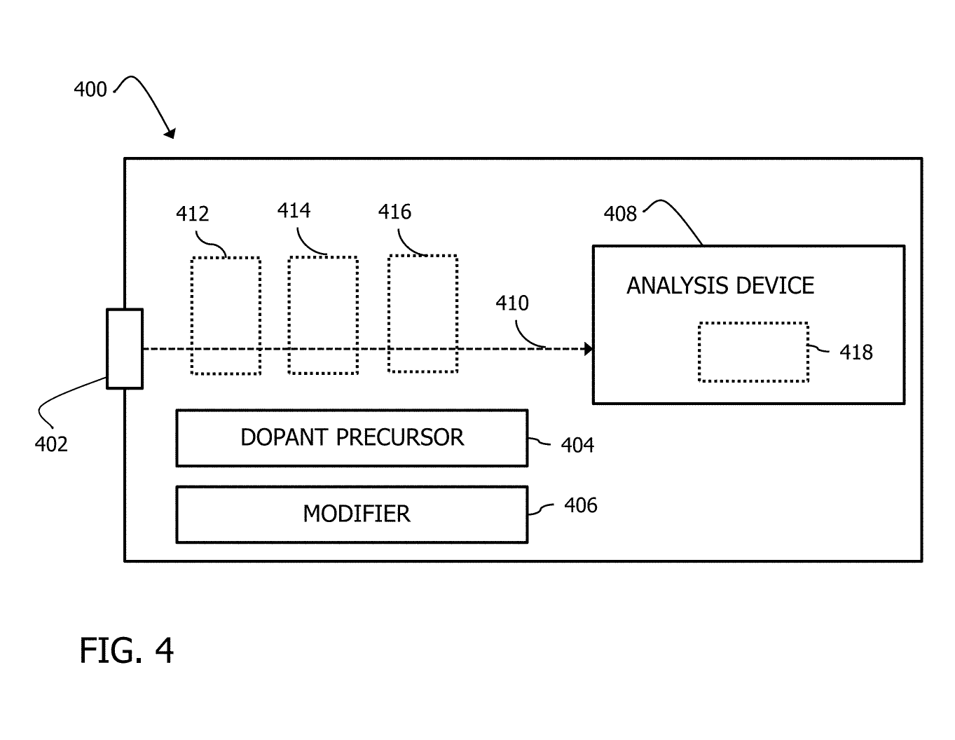

FIG. 4 is an exemplary embodiment of a block diagram of a trace detection system 400 in accordance with the present disclosure. System 400 includes an inlet 402 configured to receive a substance of interest, and a dopant precursor 404. System 400 also includes a modifier 406 configured to modify the dopant precursor 404 to release a dopant. System 400 further includes an analysis device 408 in flow communication with inlet 402, as indicated by arrow 410. Analysis device 408 is configured to perform an analysis on the substance of interest. In some embodiments, system 400 includes at least one additional component such as, for example, a sampling trap (not shown), a desorber 412, a transfer line 414, an ionization region 416, and a detector 418.

In accordance with the present disclosure, dopant precursor 404 includes at least one of urea, an organic ammonium salt, a guanidinium inorganic salt, an ammonium polyphosphate, a substituted amide, and combinations thereof. More specifically, for example, the dopant precursor 404 includes an ammonium salt of oxalic acid, an ammonium salt of a dicarboxylic acid, an ammonium salt of citric acid, an ammonium salt of a tricarboxylic acid, ammonium formate, guanidinium carbonate, and formamide. In some embodiments, each of these dopant precursors 404 are modified to release gas phase ammonia for use as a dopant in detecting a wide range of substances of interest.

In some embodiments, the modifier 406 configured to modify dopant precursor 404 comprises a heater. In these embodiments, modifying the dopant precursor includes heating the dopant precursor 404 to release a dopant. In some embodiments, the heater is a flash heater or a steady state heater. In some embodiments, the dopant precursor 404 is heated to a temperature of from about 20° C. to about 150° C., from about 40° C. to about 150° C., from about 40° C. to about 100° C., or from about 65° C. to about 100° C.

In some embodiments, the modifier 406 configured to modify dopant precursor 404 comprises a catalyst. In these embodiments, catalytic decomposition is used to modify dopant precursor 404 to release a dopant. In some embodiments, the catalysts include at least one of a metal, a metal oxide, an enzyme, and combinations thereof. In some embodiments, for example, catalytic decomposition of a dopant precursor effectively lowers a temperature required to release dopant from precursor. Accordingly, in some embodiments, modifier 406 includes both a catalyst and a heater.

In accordance with the present disclosure, it is desirable that the dopant is released from the dopant precursor at a relatively constant and well-controlled emission rate, in order to avoid adverse effects on the substance of interest peak caused by the presence of excess dopant. In some embodiments, the dopant is released from the dopant precursor at an emission rate of from about 0.1 μg/min to about 100 μg/min, from about 0.5 μg/min to about 40 μg/min, from about 5 μg/min to about 30 μg/min, or from about 15 μg/min to about 20 μg/min. In other embodiments, the dopant is introduced into the analysis device at a concentration rate of about 20 μg/min or less.

Once dopant precursor 404 has been modified by modifier 406 to release a dopant, in some embodiments the dopant is introduced into a device of system 400 to contact the substance of interest. In some embodiments, the dopant contacts the substance of interest either before or after entering analysis device 408 or detector 418. For example, in some embodiments, the dopant contacts the substance of interest at inlet 402, on a sampling trap (not shown), within desorber 412, within transfer line 414, within ionization region 416, or within detector 418.

In some embodiments, a dopant is further managed by diluting the dopant concentration within the trace detection system as desired. Accurate dilution is dependent on a well-controlled and constant emission rate from the dopant precursor. In some embodiments, a dopant is introduced into the trace detection system in a diluted or non-diluted gas flow. Additionally, in some embodiments, a dopant is introduced into the trace detection system in either a continuous or pulsed (i.e., non-continuous) manner. For example, pulsed dopant introduction can be achieved either by pulsing the heat applied to the dopant precursor (when a heater is used) or by using valves and/or pumps to control the diluted or non-diluted gas flow.

Once the dopant has been introduced into the trace detection system and contacts a substance of interest, in some embodiments the substance of interest is analyzed and detected. The ambient temperature at which detection occurs is the temperature inside or outside of a detector 418 device enclosure or analysis device 408 enclosure, depending on the embodiment. In some embodiments, detection occurs at an ambient temperature range of from about −10° C. to about 65° C., or from about 0° C. to about 65° C.

In some embodiments of the present disclosure, the analysis device 408 includes at least one of an ion mobility spectrometer (IMS), a reverse ion mobility spectrometer, an ion trap mobility spectrometer (ITMS), a drift spectrometer (DS), an aspiration ion mobility spectrometer, a non-linear drift spectrometer, a field ion spectrometer (FIS), a radio frequency ion mobility increment spectrometer (IMIS), a field asymmetric ion mobility spectrometer (FAIMS), an ultra-high-field FAIMS, a differential ion mobility spectrometer (DIMS), a differential mobility spectrometer (DMS), a drift spectrometer, a non-linear drift spectrometer, a trapped ion mobility spectrometer (TIMS), a traveling wave ion mobility spectrometer, a semiconductor gas sensor, a raman spectrometer, a laser diode detector, a mass spectrometer (MS), a gas chromatograph (GC), an electron capture detector, a photoionization detector, a chemiluminescence-based detector, an electrochemical sensor, an infrared spectrometer, a lab-on-a-chip detector, and combinations thereof.

Exemplary embodiments of detection systems for determining the presence of substances of interest, and methods of operating such systems are not limited to the specific embodiments described herein, but rather, components of systems and/or steps of the methods may be utilized independently and separately from other components and/or steps described herein. For example, the methods may also be used in combination with other systems requiring determining the presence of substances of interest, and are not limited to practice with only the substance detection systems and methods as described herein. Rather, the exemplary embodiment can be implemented and utilized in connection with many other substance detection applications that are currently configured to determine the presence of substances of interest.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

This written description uses examples to disclose the disclosure, including the best mode, and also to enable any person skilled in the art to practice the invention, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for detecting a substance of interest, the method comprising:
introducing a substance of interest into a device of a trace detection system;
heating a dopant precursor to release a dopant, wherein the dopant precursor comprises at least one of urea, an organic ammonium salt, a guanidinium inorganic salt, an ammonium polyphosphate, and a substituted amide;
introducing the dopant into the device of the trace detection system, wherein the dopant contacts the substance of interest;
performing an analysis of the substance of interest; and
detecting the substance of interest.

2. The method of claim 1, wherein heating the dopant precursor comprises heating the dopant precursor to a temperature of from about 20° C. to about 150° C.

3. The method of claim 1, wherein heating the dopant precursor comprises heating the dopant precursor to release the dopant at an emission rate of from about 0.1 μg/min to about 100 μg/min.

4. The method of claim 1, wherein introducing the dopant into the device of the trace detection system comprises introducing the dopant into at least one of a detector, a desorber, a transfer line, a sampling trap, and an ionization region.

5. The method of claim 1, wherein detecting the substance of interest comprises detecting the substance of interest at an ambient temperature range of from about −10° C. to about 65° C.

6. The method of claim 1, wherein the substance of interest includes at least one of an explosive, an energetic material, a taggant, a narcotic, a toxin, a chemical warfare agent, a biological warfare agent, a pollutant, a pesticide, a toxic industrial chemical, a toxic industrial material, a homemade explosive, a pharmaceutical trace contaminant, a biomarker for medical applications, a chemical marker for medical applications, a biomarker for clinical hygienic applications, a chemical marker for clinical hygienic applications, a precursor thereof, a byproduct thereof, a metabolite thereof, and combinations thereof.

7. A method for detecting a substance of interest, the method comprising:
introducing a substance of interest into a device of a trace detection system;
catalytically decomposing a dopant precursor to release a dopant, wherein the dopant precursor comprises at least one of urea, an organic ammonium salt, a guanidinium inorganic salt, an ammonium polyphosphate, and a substituted amide;
introducing the dopant into the device of the trace detection system, wherein the dopant contacts the substance of interest;
performing an analysis of the substance of interest; and
detecting the substance of interest.

8. The method of claim 7, wherein introducing the dopant into the device of the trace detection system comprises introducing the dopant into at least one of a detector, a desorber, a transfer line, a sampling trap, and an ionization region.

9. The method of claim 7, wherein catalytically decomposing the dopant precursor comprises decomposing the dopant precursor to release the dopant at an emission rate of from about 0.1 μg/min to about 100 μg/min.

10. The method of claim 7, wherein catalytically decomposing the dopant precursor comprises decomposing the dopant precursor using at least one of a metal, a metal oxide, an enzyme, and combinations thereof.

11. The method of claim 7, wherein detecting the substance of interest comprises detecting the substance of interest at an ambient temperature range of from about −10° C. to about 65° C.

12. The method of claim 7, wherein the substance of interest includes at least one of an explosive, an energetic material, a taggant, a narcotic, a toxin, a chemical warfare agent, a biological warfare agent, a pollutant, a pesticide, a toxic industrial chemical, a toxic industrial material, a homemade explosive, a pharmaceutical trace contaminant, a biomarker for medical applications, a chemical marker for medical applications, a biomarker for clinical hygienic applications, a chemical marker for clinical hygienic applications, a precursor thereof, a byproduct thereof, a metabolite thereof, and combinations thereof.

13. A system for detecting a substance of interest, the system comprising:
an inlet configured to receive a substance of interest;
a dopant precursor, wherein the dopant precursor comprises at least one of urea, an organic ammonium salt, a guanidinium inorganic salt, an ammonium polyphosphate, and a substituted amide;
a modifier configured to modify the dopant precursor to release a dopant; and
an analysis device coupled in flow communication with the inlet, wherein the analysis device is configured to perform an analysis on the substance of interest.

14. The system of claim 13, wherein the modifier is configured to modify the dopant precursor to release the dopant at an emission rate of from about 0.1 μg/min to about 100 μg/min.

15. The system of claim 13, wherein the modifier configured to modify the dopant precursor comprises at least one of a heater configured to heat the dopant precursor and a catalyst configured to decompose the dopant precursor.

16. The system of claim 15, wherein the heater is configured to heat the dopant precursor to a temperature of from about 20° C. to about 150° C.

17. The system of claim 15, wherein the catalyst comprises at least one of a metal, a metal oxide, an enzyme, and combinations thereof.

18. The system of claim 13, wherein the analysis device is configured to detect the substance of interest at an ambient temperature range of from about −10° C. to about 65° C.

19. The system of claim 13, wherein the substance of interest includes at least one of an explosive, an energetic material, a taggant, a narcotic, a toxin, a chemical warfare agent, a biological warfare agent, a pollutant, a pesticide, a toxic industrial chemical, a toxic industrial material, a homemade explosive, a pharmaceutical trace contaminant, a biomarker for medical applications, a chemical marker for medical applications, a biomarker for clinical hygienic applications, a chemical marker for clinical hygienic applications, a precursor thereof, a byproduct thereof, a metabolite thereof, and combinations thereof.

20. The system of claim 13, wherein the analysis device includes at least one of an ion mobility spectrometer (IMS), a reverse ion mobility spectrometer, an ion trap mobility spectrometer (ITMS), a drift spectrometer (DS), an aspiration ion mobility spectrometer, a non-linear drift spectrometer, a field ion spectrometer (FIS), a radio frequency ion mobility increment spectrometer (IMIS), a field asymmetric ion mobility spectrometer (FAIMS), an ultra-high-field FAIMS, a differential ion mobility spectrometer (DIMS), a differential mobility spectrometer (DMS), a drift spectrometer, a non-linear drift spectrometer, a trapped ion mobility spectrometer (TIMS), a traveling wave ion mobility spectrometer, a semiconductor gas sensor, a raman spectrometer, a laser diode detector, a mass spectrometer (MS), a gas chromatograph (GC), an electron capture detector, a photoionization detector, a chemiluminescence-based detector, an electrochemical sensor, an infrared spectrometer, a lab-on-a-chip detector and combinations thereof.
